(19) United States
(12) Patent Application Publication
(10) Pub. No.: US 2009/0211148 A1
(43) Pub. Date: Aug. 27, 2009

(54) Mobil Pest Eradication System

(76) Inventor: Terry Michael McCarty, Georgetown, KY (US)

Correspondence Address: JAMES M. FRANCIS, 300 W VINE ST, STOLL KEENON OGDEN PLLC, LEXINGTON, KY, 40507, US

(21) Appl. No.: 11/770,741

(22) Filed: Jun. 29, 2007

(51) Int. Cl. A01M 1/00; A01M 21/00; A01M 19/00; B23P 6/00

(52) U.S. Cl. 43/124; 29/401.1

(57) ABSTRACT

A mobile pest eradication device for heat treating wood comprising a chamber having a first end, a second end, a floor, a ceiling, a first side walls, a second side wall, and a rear wall located at said second end; at least one door at said first end of said chamber to permit access to said chamber; a heating sub-chamber located within said chamber at said second end; a treatment sub-chamber between said heating sub-chamber and said first end; at least one heater within said heating sub-chamber; an interior wall having a top and base, said interior wall being situated between said heating sub-chamber and said treatment sub-chamber and configured such that said interior wall extends from said floor to said ceiling and extends from said first side wall to said second side wall; an air outlet at the top of said interior wall to permit heated air to flow into said treatment sub-chamber; an air return at the base of said interior wall to allow air to exit said treatment sub-chamber and re-enter said heating sub-chamber; a deflecting baffle within said heating sub-chamber, said deflecting baffle sloped upward from said rear wall to said ceiling to direct heated air toward said heated air outlet; means for fueling and igniting said heater; a control unit for controlling said heater, said control unit comprising a processor and thermostatic software; and temperature sensors in said chamber arranged to communicate with said control unit.

### BACKGROUND OF THE INVENTION

1. Field of the Invention

This invention relates generally to the treatment of wood and wood products. More specifically this invention relates to the pest eradication treatment of wood and wood products. Even more specifically this invention relates to the heat treatment of wood and wood products utilized in material handling for the purpose of pest eradication by means of a mobile oven.

2. Problems in the Art

Wooden material handling materials such as pallets, dunnage, crating, packing blocks, drums, cases, load boards, pallet collars, and skids have come under increasing scrutiny for being potential sources for pest invasions which can have traumatic effects upon local plant and animal life. Wooden material handling products that are composed of raw wood, as opposed to processed wood (also known as non-manufactured wood packaging or NMWP), bear the risk of transporting pests that have bored into the wood or hidden themselves within cracks in the wood. Wood can be treated to prevent the spread of potentially harmful organisms between shipping points. Such treatment is now required under the International Plant Protection Convention (IPPC). The IPPC is recognized by the World Trade Organization as being the official body for international plant protection.

The IPPC has mandated that pallets shipped across international borders should be made of materials that are incapable of being a carrier of invasive species of insects and plant diseases. This standard is described in detail in International Standards for Phytosanitary Measures ISPM No. 15, titled “Guidelines for Regulating Wood Packaging Material in International Trade.” Raw untreated wood pallets are not compliant with ISPM 15 and can carry pests into unprotected ecosystems. To be compliant with ISPM No. 15, the pallets must be treated under the supervision of an approved agency.

A common method to eradicate pests in wooden pallets is chemical fumigation. This method is addressed by ISPM No. 15. The wood must be fumigated with methyl bromide to kill off any pests that may be transported in or on the wood. Pallets treated via this method bear the initials “MB” by the IPPC logo. Chemical fumigation, while effective, has inherent dangers. The pallets are placed in a chamber which is then filled with an airborne pesticide that can be dangerous to humans. This process bears a significant risk to possible pollution of the environment through the accidental release of the pesticide into the surrounding ecosystem. Chemical fumigation also is more difficult to implement because it must the fumigant can only be purchased and applied by licensed commercial applicators. This licensing is the responsibility of each state government which set state specific licensing and reporting requirements. Additionally, the fumigant can be expensive.

A safer and more effective method of treating wooden pallets to ensure compliance with ISPM No. 15 is by heat treatment. The wood must be heated to achieve a minimum core temperature of 56° C. for at least 30 minutes. Pallets treated via this method bear the initials “HT” by the IPPC logo. Presently, pallets must be transported to treatment centers. Transportation adds unnecessary cost into the time and overhead required for treatment.

### SUMMARY OF THE INVENTION

The present invention is a mobile device for heat-treating wooden pallets in such a way as to destroy pests. The present invention preferably utilizes an insulated wheeled trailer typically utilized as a refrigerated trailer for the over-the-road transport of refrigerated goods by truck. Propane forced air heaters are mounted in the end of the trailer opposite the doors. These propane heaters are supplied with electricity by the diesel engine acting as a generator. A control unit, a computer, is utilized to monitor thermocouples arranged along the ceiling of the trailer and adjust the output of the heaters accordingly. An interior wall is placed between the heaters and the cargo area of the trailer, resulting in the creation of two distinct sub-chambers. A door in the wall permits access to the heating sub-chamber containing the heaters from the cargo area of the trailer utilized as a treatment sub-chamber. An access panel in the rear wall of the trailer permits another point of access to the heating sub-chamber and can also serve to help ventilate the trailer during cool-down.

A baffle is installed above the heaters to direct the hot air being produced by the heaters from the heating sub-chamber to the top of the interior wall. A cutout along the top of the wall permits the heated air to flow into the treatment sub-chamber. As the air is forced through this small opening, it accelerates and gains enough momentum to reach the opposite end of the trailer. The air then returns through an air intake cutout of the bottom of the interior wall. The air intake is approximately twice the size of the air outlet at the top of the interior wall. The constant circulation of air that results facilitates the distribution of thermal energy throughout the treatment chamber and ensures effective treatment of the wooden products, typically pallets, placed within the treatment sub-chamber.

Accordingly, those skilled in the art will appreciate that the concept upon which this invention is based may readily be utilized as a basis for the design of other structures, methods, and systems for carrying out the several purposes of the present invention. It is important, therefore, that the claims and specification be regarded as including such equivalent constructions insofar as they do not depart from the spirit of the present invention.

### BRIEF DESCRIPTION OF THE DRAWINGS

FIG. 1 is a cross-sectional view of the invention from its side perspective without the attached truck.

### DETAILED DESCRIPTION OF THE INVENTION

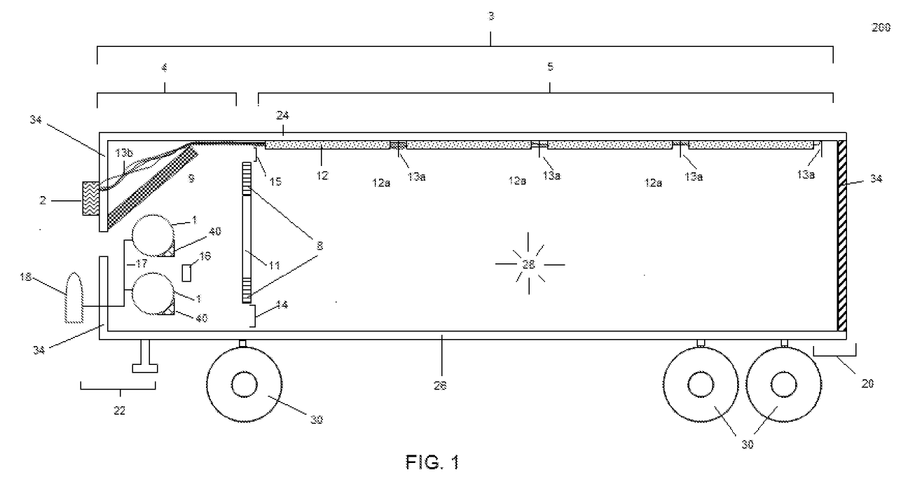

The mobile pest eradication device 100 depicted in FIG. 1 is preferably of the same structural construction as a refrigerated trailer. It possesses a first end 20, a second end 22, a ceiling 24, a floor 26, two side walls 28, and a rear wall 34. Wheels 30 are affixed via axles to the device 100 to facilitate mobility when attached to a truck. The device preferably possesses two doors 32 at the second end 22 which is distal from the truck to which the device 100 is intended to be attached. The ceiling 24, floor 26, side walls 28, doors 32 and rear wall 34 are internally insulated for efficiency.

The chamber 3 in which the wood is heated and the heaters 1 are mounted is segregated into a treatment sub-chamber 5 and a heating sub-chamber 4. The heaters 1 are preferably propane forced air because they are clean burning and being utilized in a closed environment. A preferred heater is depicted by FIG. 4. However, kerosene, diesel fuel, and jet fuel fueled heaters may also be utilized in a properly ventilated chamber. Propane is supplied to the heaters 1 from a propane source 18, typically a tank, via propane supply lines 17. The heaters 1 are electronically ignited and supplied with electricity generated by the truck's diesel engine via the heating chamber power outlet 16.

Preferably four propane forced air heaters 1 capable of producing between 225,000 and 375,000 BTU are mounted on heater racks 19 within the heating sub-chamber 4. Approximately 1.5 million BTU are preferred to properly heat the treatment sub-chamber 5. The heaters 1 preferably have integrated thermostats 40 incorporated into their controls 45. These integrated thermostats 40 are bypassed by the thermostatic software that reads data from the thermocouples 13 installed along the ceiling 24 of the chamber 3. The thermostatic software of the control unit 2 communicates directly with the controls of the heater 1. The thermocouples 13a are connected via thermocouple wires 13b back to the control unit 2 comprising a central processor that runs the thermostatic software. The wires 13b are protected from physical damage by passing them through a protective conduit 12 between the exposed thermocouples 13a.

The heaters 1 are supplied with fuel, preferably propane, by fuel supply lines 17 that transfer fuel from a fuel tank 18 to the heaters 1. The fuel tank 18 is mounted externally to either the truck 100 or the trailer 200. Propane is preferred because it is a relatively clean burning fuel.

An interior wall 8 segregates the heating sub-chamber 4 and treatment sub-chamber 5. The segregation is not complete because the interior wall 8 possesses a heated air outlet 15 between the interior wall 8 and ceiling 24 that provides a channel to facilitate the movement of heated air into the treatment sub-chamber 5. An air return 14 at the base of the interior wall 8 facilitates the return of the heavier, cooler air. The interior wall 8 also serves as a baffle helping to regulate the air flow throughout the chamber 3. The heated air from the heating sub-chamber 4 rises to a deflecting baffle 9 installed at the second end 22 of the chamber 3. The deflecting baffle 9 rises from the rear wall 34 to the ceiling 24 such that air rising from the heaters 1 will engage the deflecting baffle 9 and be directed not only to the ceiling 24 but also back to the treatment sub-chamber 5 through the heated air outlet 15 at the top of the interior wall 8. Directing the air in such a manner adds a horizontal velocity component to the flow of the heated air. The interior wall 8 acts as an air dam and prevents the movement of air except through the heated air outlet 15 and the air return 14. The relatively small space of the heated air outlet 15 through which the heated air must flow accelerates the air as it enters the treatment chamber 5. This improves airflow to the first end 20 of the chamber 3 and facilitates a more even distribution of heat throughout the treatment sub-chamber 5.

The heated air sinks towards the floor 26 of the treatment sub-chamber 5 as it cools. The air then recirculates back to the heating sub-chamber 4 through the air return 14. The air return 14 being of greater size than the heated air outlet 15 and lacking the forced introduction of air through the air return 14 is the point of least resistance for air leaving the treatment chamber 5. The returned air is subsequently reheated by the heaters 1 and reintroduced into the treatment sub-chamber 5. This cycle repeats until the heaters 1 are eventually turned off.

The output and firing of the heaters 1 are controlled by a control unit 2. The control unit 2 comprises a processor which runs thermostatic software, preferably Redline, to control the heaters 1 based upon the signals received from the thermocouples 13a. If an area of the heating sub-chamber 5 fails to sufficiently heat, the output of the heaters 1 can be increased by the control unit 2. Likewise, if the treatment sub-chamber 5 is too hot the control unit 2 can reduce the output of the heaters 1. The heaters 1 can also be turned on and off by the control unit 2. Electric power to the control unit 2 and to the heaters is preferably provided by electricity generated by the truck's diesel engine.

Thermocouples 13a are arranged across the ceiling 24 of said chamber 3. They are preferably connected to the control unit 2 by thermocouple wires 13b and arranged to be read by said control unit 2. The thermocouple wires 13b are preferably arranged to run along the ceiling 24 to the control unit 2 such that they can be connected and read by the control unit 2. The thermocouple wires 13b are preferably protected by a conduit 12 through which they pass. The thermocouples 13a are exposed to the chamber 3 environment through thermocouple passages 12a in the conduit 12. It is anticipated that the thermocouples 13a could also be arranged to communicate wirelessly to the control unit 2.

What is claimed is:

1. A mobile pest eradication device for heat treating wood comprising:
a. a chamber having a first end, a second end, a floor, a ceiling, a first side walls, a second side wall, and a rear wall located at said second end;
b. at least one door at said first end of said chamber to permit access to said chamber;
c. a heating sub-chamber located within said chamber at said second end;
d. a treatment sub-chamber between said heating sub-chamber and said first end;
e. at least one heater within said heating sub-chamber;
f. an interior wall having a top and base, said interior wall being situated between said heating sub-chamber and said treatment sub-chamber and configured such that said interior wall extends from said floor to said ceiling and extends from said first side wall to said second side wall;
g. an air outlet at the top of said interior wall arranged to permit heated air to flow into said treatment sub-chamber;
h. an air return at the base of said interior wall arranged to allow air to exit said treatment sub-chamber and re-enter said heating sub-chamber;
i. means for supplying fuel to said heater;
j. means for providing power to said heater;
k. means for directing heated air from said heating sub-chamber to said treatment sub-chamber;
l. a control unit for controlling said heater, said control unit comprising a processor and thermostatic software; and
m. temperature sensors in said chamber arranged to communicate with said control unit.

2. The chamber described in claim 1, said chamber comprising a wheeled trailer capable of being pulled by a truck.

3. The mobile pest eradication device described in claim 2, said device possessing means for being electrically powered by said truck engine.

4. The mobile pest eradication device described in claim 2, said temperature sensors comprising thermocouples.

5. The mobile pest eradication device described in claim 4, wherein said thermocouples are installed along said ceiling of said chamber.

6. The mobile pest eradication device described in claim 5, wherein said thermocouples are wiredly connected to said control unit.

7. The mobile pest eradication device described in claim 5, wherein said thermocouples are wirelessly connected to said control unit.

8. The mobile pest eradication device described in claim 6, wherein said wires are passed through a protective conduit along said ceiling of said chamber.

9. The mobile pest eradication device described in claim 4, said means for controlling said heater comprising a computer processor and thermostatic software capable of adjusting heater output based upon data received from said thermocouples.

10. The mobile pest eradication device described in claim 1, further comprising at least one heater mounting rack within said heating sub-chamber.

11. The mobile pest eradication device described in claim 1, further comprising at least one electrical outlet within said heating sub-chamber.

12. The mobile pest eradication device described in claim 1, wherein said chamber is insulated.

13. The mobile pest eradication device described in claim 1, wherein said heater is a forced air heater fueled by an organic fuel.

14. The mobile pest eradication device described in claim 13, wherein said fuel is selected from the group consisting of propane, kerosene, diesel fuel, and jet fuel.

15. The mobile pest eradication device described in claim 14, wherein said heater has an integrated controlling electronic thermostat.

16. The mobile pest eradication device described in claim 15, wherein said control unit bypasses said integrated thermostat to directly control said heater.

17. The mobile pest eradication device described in claim 1, further comprising at least one removable door within said interior wall to permit access to said heating sub-chamber from said treatment sub-chamber.

18. The mobile pest eradication device described in claim 1, further comprising a removable panel at said second end in said rear wall.

19. The mobile pest eradication device described in claim 1, wherein said chamber is substantially shaped like a rectangular box.

20. The mobile pest eradication device described in claim 1, wherein said chamber is substantially cylindrical.

21. The mobile pest eradication device described in claim 1, said means for directing heated air from said heating sub-chamber to said treatment sub-chamber comprising a deflecting baffle within said heating sub-chamber, said deflecting baffle sloped upward from said rear wall to said ceiling to direct rising heated air toward said air outlet.

22. The mobile pest eradication device described in claim 1, said means for directing heated air from said heating sub-chamber to said treatment sub-chamber comprising a fan.

23. The method of converting a refrigerated truck trailer having a first end, a second end, a ceiling, a floor, and at least two side walls into a mobile pest eradication device for treating wood by installing a plurality of heaters in place of the refrigeration unit at said second end of said trailer, installing an interior wall with an air outlet at the top of said wall and an air inlet at the base of said wall, said interior wall installed between said first end of said trailer and said plurality of heaters so as to leave a ceiling gap at the top of said interior wall and a floor gap at the bottom of said interior wall, said air outlet being smaller than said air inlet, installing a means for directing air heated by said heaters through said air outlet, and installing means to power and fuel said heaters.

24. A mobile pest eradication device for heat treating wood pallets comprising:
a. An insulated chamber having a first end, a second end, a floor, a ceiling, a first side wall, a second side wall, and a rear wall located at said second end;
b. said chamber further comprising at least one door at said first end;
c. a heating sub-chamber located within said chamber at said second end;
d. a treatment sub-chamber between said heating sub-chamber and said first end;
e. a plurality of propane forced air heaters mounted within said heating sub-chamber;
f. an interior wall having a top and base, said interior wall being situated between said heating sub-chamber and said treatment sub-chamber and configured such that said interior wall extends from said floor to said ceiling and extends from said first side wall to said second side wall;
g. an air outlet at the top of said interior wall;
h. an air return at the base of said interior wall;
i. at least one removable door within said interior wall to permit access to said heating sub-chamber from said treatment sub-chamber;
j. a removable panel at said second end to permit access to said heating sub-chamber through said rear wall;
k. a deflecting baffle within said heating sub-chamber, said deflecting baffle sloped upward from said rear wall to said ceiling to direct heated air toward said heated air outlet;
l. a control unit for controlling said heaters, said control unit comprising a processor and thermostatic software;
m. thermocouples affixed to said ceiling of said chamber and arranged to communicate with said control unit; and
n. conduits along said ceiling of said chamber, said conduits possessing thermocouple passages, and
o. wheels externally affixed to said chamber via axles.
